(19) United States
(12) Patent Application Publication
(10) Pub. No.: US 2016/0109113 A1
(43) Pub. Date: Apr. 21, 2016

(54) Emergency Light and Emergency Reporting System

(71) Applicant: Hosiden Corporation, Yao-shi (JP)

(72) Inventors: Kimitake Sasaki, Yao-shi (JP); Sho Matsui, Yao-shi (JP)

(21) Appl. No.: 14/887,778

(22) Filed: Oct. 20, 2015

(30) Foreign Application Priority Data
Oct. 20, 2014 (JP) 2014-213838

(51) Int. Cl. F21V 33/00; F21V 7/04

(52) U.S. Cl. CPC F21V 33/0076; F21V 33/0052; F21V 7/04; F21Y 2101/02

(57) ABSTRACT

Provided is an emergency light that can be readily carried by a person even when the person goes outdoors and that can signal occurrence of an emergency. The emergency light includes an illumination light emitting unit that emits light for illumination to a surrounding, a signaling light emitting unit that emits light for signaling occurrence of an emergency to the surrounding, the signaling light emitting unit being provided separately of the illumination light emitting unit, and a transmitter that transmits identifier information over a predetermined area when the signaling light emitting unit has emitted a signaling light.

### CROSS REFERENCE TO RELATED APPLICATION

This application claims priority to Japanese Patent Application No. 2014-213838 filed Oct. 20, 2014, the disclosure of which is herein incorporated in its entirety by reference.

### TECHNICAL FIELD

This disclosure relates to an emergency light for signaling occurrence of an emergency and relates also to an emergency reporting system having such emergency light.

### RELATED ART

For example, a man when going to a mountain or the sea may be involved in a distress accident. A man even when being present in a house may suffer a sediment disaster or the like. In the event of such distress accident or a sediment disaster (to be collectively referred to “an accident or the like” hereinafter), when the person involved in such accident or the like is to be searched, success of rescue will be much higher if the location of the person can be specified speedily. An example of technique for specifying whereabouts of a person involved in an accident or the like is known from JP2005-223604A for instance.

JP2005-223604A discloses a remote controller for an electronic device with disaster prevention function. This remote controller includes, in addition to the remote operation function for a TV set or the like, a light emitting means, and a transmitting means for transmitting a radio wave signal or an audio signal for location search and rescue, separately of a signal for the remote controller. With this remote controller in operation, in a first operation mode, the transmitting means for radio wave signal is activated; and in a second operation mode, at least one of the light emitting means and the audio signal transmitting means is activated. With this, if a person is locked up in a house which has been collapsed by an earthquake or the like, search of the person's location is made possible.

### SUMMARY

In the technique disclosed in JP2005-223604A, the light emitting means and the transmitting means are provided in a remote controller for e.g. a television set. Therefore, it is assumed that this controller will be kept handy only near a user who is present around an electric device or appliance (e.g. a television set) to be operated by this remote controller. Therefore, the technique disclosed in JP2005-223604A is not designed in consideration to an occasion of a person going outdoors such as going to a mountain or the sea, not to say an event of sediment disaster.

Embodiments of the present invention comprise an emergency light that can be readily carried by a person even when the person goes outdoors and that can signal occurrence of an emergency and an emergency reporting system having such emergency light.

An emergency light according to one embodiment of this disclosure comprises:

an illumination light emitting unit that emits light for illumination to a surrounding;

a signaling light emitting unit that emits light for signaling occurrence of an emergency to the surrounding, the signaling light emitting unit being provided separately of the illumination light emitting unit; and

a transmitter that transmits identifier information over a predetermined area when the signaling light emitting unit has emitted a signaling light.

In the case of the above-described configuration, when it is dark in the surrounding, the surrounding of a person can be lit by the illumination light from the illumination light emitting unit. Further, in the event of an emergency, occurrence of this emergency can be visually signaled to the surrounding by the signaling light from the signaling light emitting unit. Moreover, with transmission of identifier information by the transmitter, it is possible to inform whereabouts of a person even in a situation of poor visibility and/or poor audibility. In this way, the emergency light has not only a function of illumination device such as a flashlight or torch, but also an reporting function at the time of emergency. Thus, the lamp can be readily carried to outdoors and can signal occurrence of an emergency if any.

Further, according to one embodiment of the emergency light, the emergency light further comprises a reflector plate with reflecting material for reflecting light applied to opposed faces thereof', and the reflector plate is configured to reflect the illumination light by one of the opposed faces thereof and reflect the signaling light by the other face thereof.

In this case, the reflector plate can reflect the illumination light from the illumination light emitting unit and the signaling light from the signaling light emitting unit, respectively in a favorable manner. Therefore, light reflection efficiency can be increased, so that with increase of amount of light emitted from this emergency light, effective visual reporting is made possible even with low electric power consumption. Further, if the light is driven with low power consumption, the light can be used for a longer period.

An emergency reporting system according to one embodiment of this disclosure comprises:

the above-described emergency light; and

a communication means that effects an emergency reporting indicative of reception of the identifier information from the emergency light when the identifier information is received from the transmitter.

In the case of the above-described configuration, an emergency reporting is possible automatically upon reception of identifier information, without need to operatively couple the emergency light and the communication means to each other in advance. Therefore, provided the communication means is present at a location that can be reached by the identifier information from the transmitter, reporting can be made automatically without a user's searching for communication means.

According to one embodiment of the emergency reporting system, the system further comprises a displaying means that causes displaying of reception information indicative of reception of the identifier information from the emergency light when the identifier information is received from the transmitter.

In this case, reception of identifier information can be signaled visually. Therefore, overlooking of reception of identifier information can be prevented.

### BRIEF DESCRIPTION OF THE DRAWINGS

FIG. 1 is a perspective view showing an emergency light,

FIG. 2 is a view showing a light emitting state of an illumination light emitting unit,

FIG. 3 is a view showing a light emitting state of a signaling light emitting unit,

FIG. 4 is a schematic diagram of a reporting system, and

FIG. 5 is a schematic diagram of a reporting system relating to a further embodiment.

### DESCRIPTION OF EMBODIMENTS

### 1. Emergency Light

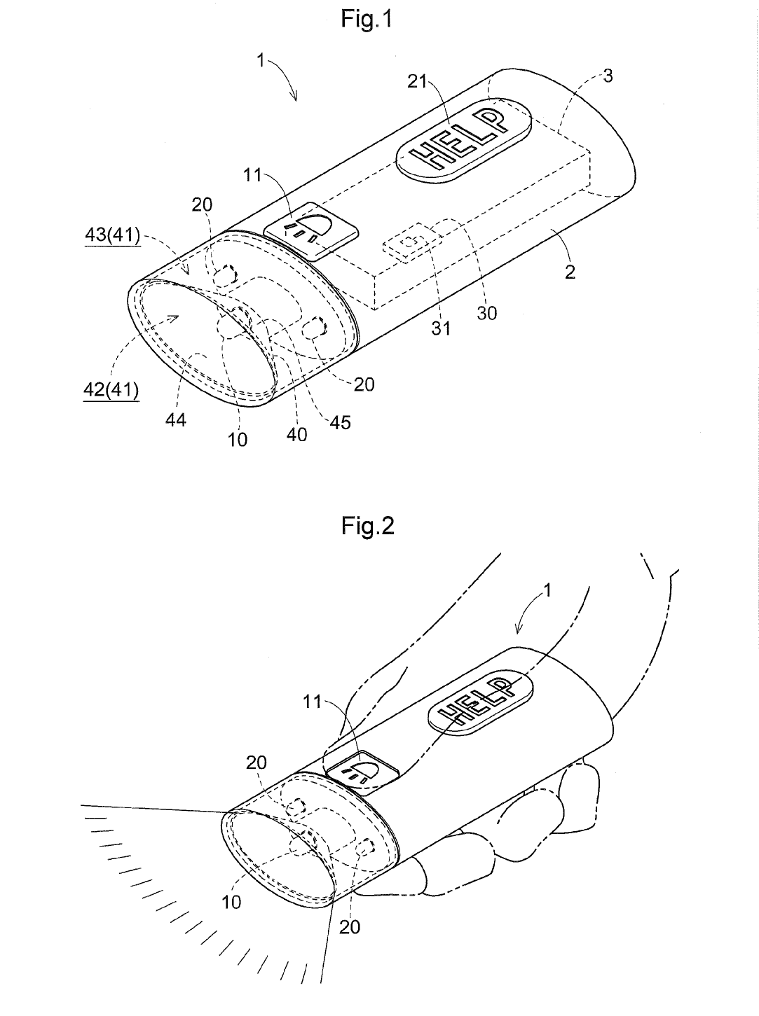

An emergency light relating to this disclosure is configured to be capable of reporting occurrence of an emergency to a surrounding. Next, an emergency light 1 relating to this embodiment will be explained. FIG. 1 shows a perspective view of the emergency light 1. The emergency light 1 includes an illumination light emitting unit 10, signaling light emitting units 20, a transmitter 30, and a reflector plate 40.

The illumination light emitting unit 10 emits light for illumination to the surrounding. Here, illumination of surrounding is not limited to illumination of an area of 360 degrees around the illumination light emitting unit 10, but also local (limited) illumination over a certain predetermined angular range less than 360 degrees. The language “light for illumination (or illumination light)” means light emitted for illuminating surrounding of a dark site. This illumination light can be e.g. white LED (light emitting diode) light advantageously. Needless to say, LED light of any other color too can be used or an electric candescence lamp or a fluorescent lamp too can also be used. The illumination light emitting unit 10 emits light when an illumination press button 11 provided in a body portion 2 is depressed. This illumination press button 11 can be a so-called press switch or can also be a so-called slide switch. Needless to say, any other type of switch such as a toggle switch, too can be used.

The signaling light emitting units 20 emit light for signaling occurrence of an emergency to the surrounding. The term “emergency” means occurrence or development of some non-normal situation. Therefore, in order to achieve greater recognizability of emergency occurrence by anyone present in the surrounding, light having visually conspicuous color will be used as light for the signaling. As some examples of such color, red, orange, etc. which is distinct from the color used for the illumination light from the illumination light emitting unit 10 can be used advantageously. With this, it becomes easier for one or those present around to recognize occurrence of an emergency. Further, the signaling light emitting unit 20 can emit the light continuously, but can also emit the light intermittently for greater visual conspicuousness. This signaling light emitting unit 20 can use an LED light, like the illumination light emitting unit 10 or can use a candescent lamp or a fluorescent lamp. The signaling light emitting unit 20 will illuminate or dis-illuminate in association with a pressing on an emergency button 21 provided in the body portion 2. This emergency emergency button 21 can be a so-called press switch or can also be a so-called slide switch. Needless to say, any other type of switch such as a toggle switch, too can be used.

The signaling light emitting units 20 are provided separately of the illumination light emitting unit 10. Here, the language “provided separately” means that the signaling light emitting units 20 and the illumination light emitting unit 10 are provided as separate units and not used in common and the language also means that the emergency light 1 includes at least one pair of the signaling light emitting unit 20 and the illumination light emitting unit 10. In the instant embodiment, as shown in FIG. 1, the illumination light emitting unit 10 is comprised of one white LED, whereas the signaling light emitting unit 20 is comprised of two red LED's.

The transmitter 30 transmits identifier information over a predetermined area in response to emission of the signaling light from the signaling light emitting unit 20. Here, the language “emission of the signaling light from the signaling light emitting unit 20” means depression of the emergency button 21 in this embodiment. The language “identifier information” means a signal including information that allows identification of the transmitter 30. Advantageously, this information can be information that allows specification or identification of the transmitter 30 or information that allows specification or identification of a user having/carrying the emergency light 1. The transmitter 30 is configured to transmit the signal including the identifier information continuously until power of a storage cell (secondary cell) 3 provided in the emergency light 1 is used up. Advantageously, an arrangement will be provided such that once the transmitter 30 has started transmission of the identifier information, transmission of the signal including the identifier information will be continued even when the illumination light emitting unit 20 is turned off.

Incidentally, as the storage cell 3, various kinds of cells or batteries can be employed. Among them, a magnesium cell can be employed advantageously. With this, as such cell is light-weight and advantageous for long-term storage, the cell can be made ready for use with supply of water thereto, without any concern for flat battery or liquid leakage at the time of emergency. And, in the event of exhaustion of moisture content in the magnesium cell, the cell can be used again with supply of water thereto.

Advantageously, the transmitter 30 includes a storage section 31 comprised of e.g. a memory, which section 31 can store identifier information in advance. And, in response to a pressing on an emergency button 21, the identifier information will be read from the storage section 31 and this information will be transmitted from the transmitter 30. Incidentally, this transmission of identifier information by the transmitter 30 can utilize various types of communication techniques (communication according to the wireless LAN or near-field radio communication standard). For instance, by implementing the communication according to the near-field radio communication standard, it becomes possible to achieve power saving of the transmitter 30. Accordingly, the amount of power to be stored in the storage cell 3 will be reduced and even when the signaling light emitting unit 20 becomes unable to emit any signaling light, the transmitter 30 will still be able to transmit the identifier information continuously.

The reflector plate 40 will be disposed in opposition to the illumination light emitting unit 10 and the signaling light emitting unit 20, so as to reflect the illumination light from the illumination light emitting unit 10 and the signaling light from the signaling light emitting unit 20. In the instant embodiment, the reflector plate 40 has reflecting material for reflecting light applied on opposed faces thereof and this reflector plate 40 is disposed in such a manner as to partition a space 41 in which the illumination light emitting unit 10 and the signaling light emitting unit 20 into an illumination space 42 in which the illumination light emitting unit 10 is provided and a signaling space 43 in which the signaling light emitting unit 20 is provided.

With the above-described arrangement, one face 44 of the reflector plate 40 is disposed to face the illumination light emitting unit 10 side and the other face 45 of the reflector plate 40 is disposed to face the signaling light emitting unit 20 side, respectively. Consequently, the reflector plate 40 can reflect the illumination light by its one face 44 and reflect the signaling light by its other face 45.

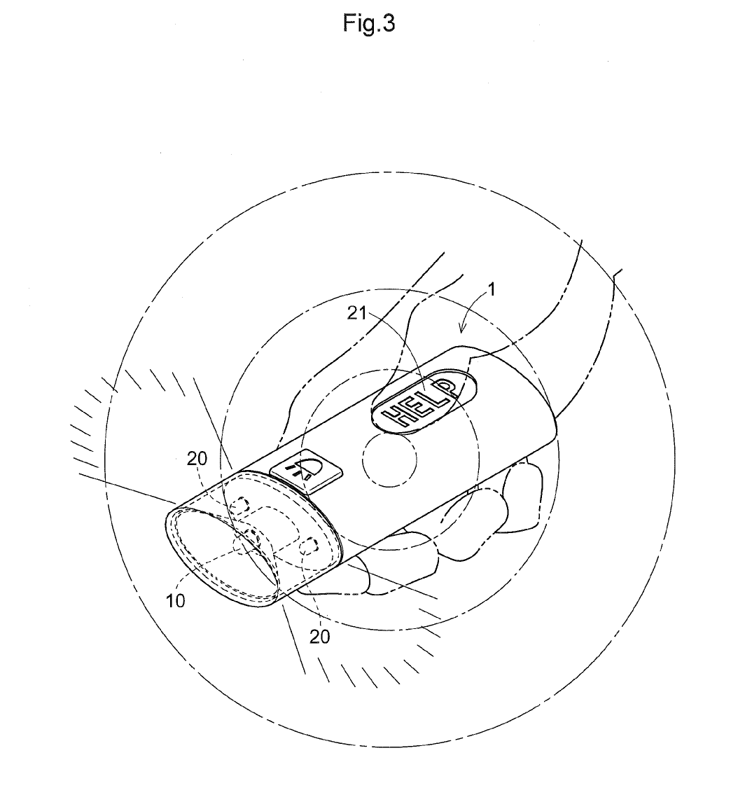

With the above-described configuration of the emergency light 1, as shown in FIG. 2, when the illumination button 11 is depressed, the lamp 1 can function as an illumination device (e.g. a flashlight) for illuminating the surrounding with the illumination light from the illumination light emitting unit 10. On the other hand, as shown in FIG. 3, when the emergency button 21 is depressed, the lamp can report occurrence of an emergency to the surrounding with the signaling light from the signaling light emitting unit 20 and also can transmit the identifier information capable of identifying the emergency light 1 as indicated by the dotted chain line, thus informing the location where the emergency light 1 is currently present.

### 2. Emergency Reporting System

Next, an emergency reporting system relating also to the present disclosure will be explained. The emergency reporting system according to this disclosure is configured to be capable of reporting occurrence of an emergency farther than the transmission area of the transmitter 30 transmitting the identifier information, in response to reception of the identifier information from the emergency light. Next, an emergency reporting system 100 according to this embodiment will be explained.

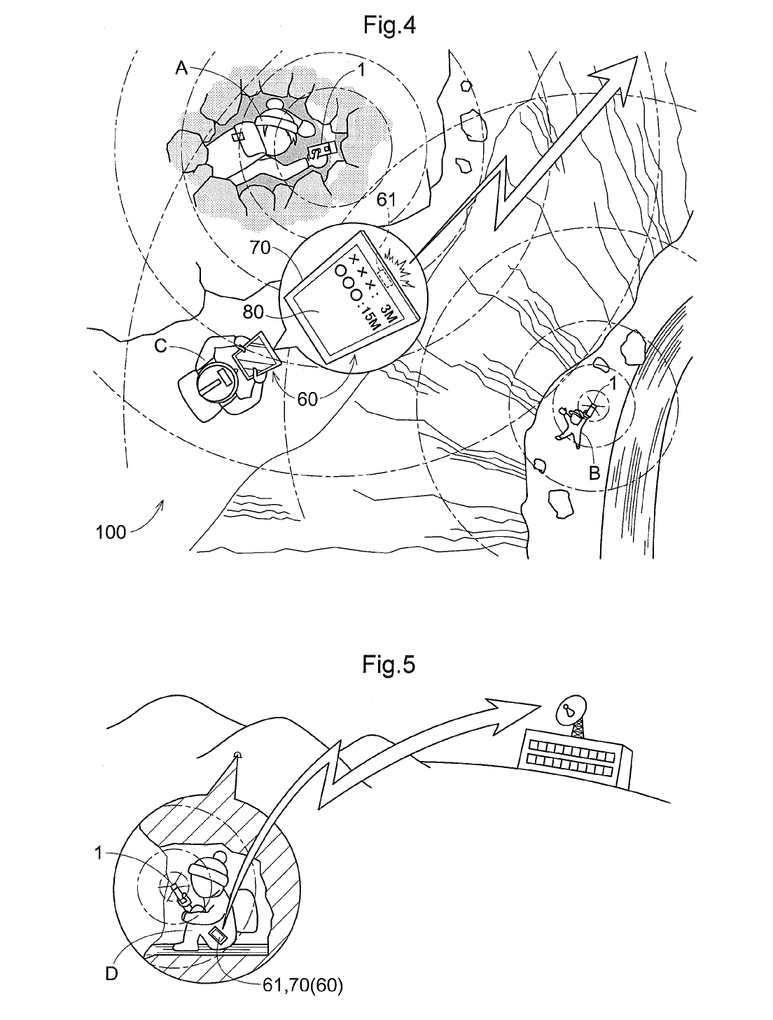

FIG. 4 shows a schematic diagram of the emergency reporting system 100. As shown in FIG. 4, the emergency reporting system 100 according to this embodiment includes the emergency light 1, a reporting means 70, and a displaying means 80. In particular, the communication means 70 and the displaying means 80 are comprised of hardware and/or software including a CPU as a core component thereof, for implementing various processings for reporting occurrence of an emergency.

In the case of the illustration in FIG. 4, a user A and a user B respectively caries an emergency light 1. As this emergency light 1 is same as the one described above, explanation thereof will be omitted here.

A terminal 60 includes a receiver unit 61 for receiving the identifier information from the transmitter 30 of the emergency light 1. As described above, from the transmitter 30, the identifier information will be transmitted over a predetermined area and if the receiver unit 61 is present within this area, the receiver unit 61 receives this identifier information. Upon reception of the identifier information, the receiver unit 61 transmits reception result to the communication means 70 which will be described later.

The communication means 70 effects emergency reporting to indicate reception of the identifier information from the emergency light 1 in case the receiver unit 61 has received the identifier information from the transmitter 30. In the instant embodiment, the communication means 70 comprises an application incorporated in the terminal 60 carried by a user C. Here, the term “emergency reporting” means reporting of the user of the emergency light 1 or a person nearby being involved in an emergency. Such reporting can be effected by e.g. a telephone call, a mail, etc. Therefore, advantageously, the terminal 60 includes a communication function capable of transmitting a phone call, a mail or the like. With this, the communication means 70 can effect emergency reporting to indicate and report reception of the identifier information from the emergency light 1.

The displaying means 80 causes displaying of reception information indicative of reception of the identifier information from the emergency light 1 when the identifier information has been received from the transmitter 30. In this embodiment, this displaying means 80 too, like the communication means 70, is comprised of an application incorporated in the terminal 60 carried by the user C. Upon reception of the identifier information, the receiver unit 61 of the terminal 60 will calculate a distance from this receiver unit 61 to the emergency light 1, based on a strength (signal strength) of this identifier information. Also, when the receiver unit 61 receives the identifier information, the receiver unit 61 transmits reception result and calculation result to the displaying means 80. Then, the displaying means 80 will display the results transmitted from the receiver unit 61 on a display screen of the terminal 60.

In the case of the example illustrated in FIG. 4, it is shown that a mark “xxx” indicative of the ID included in the identifier information from the emergency light 1 carried by the user A is located at a position of “3 m” therefrom, and a mark “ooo” indicative of the ID included in the identifier information from the emergency light 1 carried by the user B is located at a position of “15 m” therefrom, respectively. Such ID's can be set in advance for each emergency light 1 or can indicate a contact address together with a name, a nickname or the like of the user, for example.

### 3. Other Embodiments

The reflector plate 40 has been explained as this reflects the illumination light with its one face 44 and reflects the signaling light with its other face 45. However, the reflector plate 40 can be configured to reflect both the illumination light and the signaling light with its same face. In this case, the reflecting material will be applied to only one face of the reflector plate 40 which one face is used for reflecting the lights.

In the foregoing embodiment, the displaying means 80 has been explained as this causes the display screen of the terminal 60 to display the reception information indicative of reception of the identifier information from the emergency light 1 when the receiver unit 61 has received the identifier information from the transmitter 30. However, it is also possible to configure such that the display screen of the terminal 60 is not caused to display the reception information indicative of reception of the identifier information from the emergency light 1 even when the receiver unit 61 has received the identifier information from the transmitter 30. In this case, the displaying means 80 can be omitted.

Needless to say, the emergency reporting system 10 can be configured with including only the displaying means 80, not including the communication means 70. In this case, the user C carrying the terminal 60 will be a person who searches the user A or the user B, and the whereabouts of the user A or the user B can be readily found based on the identifier information.

In the foregoing embodiment, it was explained that the emergency light 1 is carried by the user A and/or the user B and the terminal 60 incorporating the communication means 70 is carried by the user C. However, it is also possible to configure such that both the emergency light 1 and the terminal 60 incorporating the communication means 70 are carried by a same user. Such configuration is illustrated in FIG. 5. In this case, when a user D encounters an emergency, this user D by himself or herself will transmit the identifier information with using his/her own emergency light 1 and this identifier information will be received by the receiver unit 61 of the terminal 60 carried by this user D. Then, the communication means 70 can automatically make reporting by a telephone call or the like to an institution of supervisory authorities or the like.

In the foregoing embodiment, it was explained that the communication means 70 and the displaying means 80 respectively comprise an application incorporated in the terminal 60. However, it is also possible to configure one or both of the communication means 70 and the displaying means 80 as a device(s) (hardware).

This disclosure is applicable to an emergency light for signaling occurrence of an emergency as well as to an emergency reporting system having such emergency light.

1. An emergency light comprising:
an illumination light emitting unit that emits light for illumination to a surrounding;
a signaling light emitting unit that emits light for signaling occurrence of an emergency to the surrounding, the signaling light emitting unit being provided separately of the illumination light emitting unit; and
a transmitter that transmits identifier information over a predetermined area when the signaling light emitting unit has emitted a signaling light.

2. The emergency light according to claim 1, wherein the emergency light further comprises a reflector plate with reflecting material for reflecting light applied to opposed faces thereof; and
the reflector plate is configured to reflect the illumination light by one of the opposed faces thereof and to reflect the signaling light by the other face thereof.

3. An emergency reporting system comprising:
the emergency light according to claim 1; and
a communication means that effects an emergency reporting indicative of reception of the identifier information from the emergency light when the the identifier information is received from the transmitter.

4. The emergency reporting system according to claim 3, wherein the system further comprises a displaying means that causes displaying of reception information indicative of reception of the identifier information from the emergency light when the identifier information is received from the transmitter.
